(19) United States
(12) Patent Application Publication
(10) Pub. No.: US 2025/0027750 A1
(43) Pub. Date: Jan. 23, 2025

(54) ADAPTIVE PROTECTIVE RESPONSE VEHICLES FOR ENHANCED PUBLIC SAFETY

(71) Applicant: Xiaoran Wang, McKinney, TX (US)

(72) Inventor: Xiaoran Wang, McKinney, TX (US)

(21) Appl. No.: 18/776,039

(22) Filed: Jul. 17, 2024

Related U.S. Application Data
(60) Provisional application No. 63/527,303, filed on Jul. 17, 2023.

(51) Int. Cl. F41H 7/02; F41H 3/00; F41H 9/00; F41H 13/00; H04W 4/90

(52) U.S. Cl. CPC F41H 7/02; F41H 3/00; F41H 9/00; F41H 13/0012; H04W 4/90

(57) ABSTRACT

The present disclosure pertains to an emergency response vehicle designed for human-powered operation with the versatility to function both indoors and outdoors. The vehicle is particularly suited for deployment in high-risk areas to offer protection in emergency situations. It features a manually operable control system that allows for intuitive navigation, akin to the operation of a standard bicycle, making it accessible for users of all competencies. Emphasized within the vehicle's design is an integrated defense mechanism forged with bullet-resistant materials, aimed at safeguarding the operator amidst harmful scenarios, while the vehicle itself acts as a mobile protective barrier. Additionally, the vehicle is equipped with a built-in offense system incorporating multiple non-lethal deterrents, providing a range of defensive options against potential threats. These features make the vehicle an asset for emergency response activities, enhancing safety and crisis management in environments susceptible to violent incidents.

### CROSS-REFERENCE TO RELATED APPLICATION(S)

This application claims the benefit of U.S. Provisional Application No. 63/527,303, filed Jul. 17, 2023, the disclosure of which is incorporated herein by reference as if set forth in full.

### TECHNICAL FIELD

This disclosure relates to aircraft accessibility devices, and more particularly, to adaptive protective response vehicles for enhanced public safety.

### BACKGROUND

In recent times, there has been an alarming increase in mass shooting events in public spaces such as schools, universities, and commercial buildings. This escalation has underscored the critical need for innovative protective measures to safeguard individuals in these vulnerable environments. There is a need for innovative safety solutions to address the rising concern for personal security in public areas, particularly in response to the threat of violence and active shooter situations.

### BRIEF DESCRIPTION OF THE DRAWINGS

FIGS. 1A-IC depict illustrative schematic diagrams for Modular Safety Vehicle, in accordance with one or more example embodiments of the present disclosure.

FIGS. 2A-2H depict illustrative schematic diagrams for Modular Safety Vehicle, in accordance with one or more example embodiments of the present disclosure.

FIGS. 3A-3C depict illustrative schematic diagrams for a Modular Safety Vehicle, in accordance with one or more example embodiments of the present disclosure.

FIG. 4 illustrates a flow diagram of a process for an illustrative Modular Safety Vehicle system, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them.

With an upsurge in public safety concerns, particularly revolving around mass shooting incidents, there is an imperative to design and implement advanced protective measures. Public spaces such as schools, colleges, shopping malls, corporate buildings, and stadiums host large gatherings, making them susceptible to such emergencies. The conceptualization of a deployable vehicle aims to address this vulnerability, offering a shielding mechanism to defend occupants in the event of an unforeseen attack. This vehicle would not only provide sanctuary but also be a beacon of preparedness, instilling a sense of security among the populace.

Additionally, the adaptability of this system to conform to the diverse settings of both indoor and outdoor public domains enhances its utility. Redesign capabilities allow it to blend seamlessly with the dynamic conditions of open-air environments like school playgrounds and flea markets and during significant public events. The inclusion of convertible features like extendable protective barriers or quick transformation mechanisms serves to prepare for a variety of scenarios, ensuring agile and comprehensive protection.

Moreover, in anticipation of rapid technological advancements, the vehicle's operational blueprint could evolve to accommodate electronic controls or electric-powered movement. This forward-thinking approach would streamline defensive measures with state-of-the-art navigation systems and automated response functions, elevating the efficiency and speed of protective actions. The integration of smart technologies represents a proactive stride towards harnessing innovation for enhanced safety, specifically in critical response times when every second counts.

Example embodiments of the present disclosure relate to systems, methods, and devices for adaptive protective response vehicles for enhanced public safety.

In various embodiments, this disclosure outlines the novel concept for a bullet-resistant, human-powered vehicle, primarily envisaged for enhancing safety during mass shooting incidents. The design aims to fit within standard door frames, enabling use in educational institutions and other facilities, and features ballistic protection through specific materials and construction. It introduces innovative features such as variable human power amplification, self-locking capability, and non-electronic operation, positioning it as a potential tool for increased personal security in vulnerable public spaces.

The system is described as a multi-purpose vehicle that provides protection in various high-occupancy venues like schools, colleges, shopping malls, corporate buildings, and stadiums. This deployment versatility is crucial, as these locations often have large numbers of people and complex layouts, making them challenging environments for ensuring safety during high-risk events such as mass shootings. Enhanced with potential features such as ballistic protection and modular design for rapid deployment, this vehicle could be a critical asset in emergency response protocols.

Further, the vehicle's design is not static; it can be reconfigured or upgraded to suit outdoor environments adjacent to its initial deployment sites, such as school playgrounds, flea markets, or public gatherings in the capital city. This adaptability is significant because it extends the potential use case of the vehicle beyond indoor confines, allowing it to provide security in open spaces where people might be at risk and where traditional security measures may be less effective. Enhancements here might include all-terrain capability and weather-resistant materials, enabling the vehicle to operate under various environmental conditions.

Further, the system may facilitate the vehicle's transition from being manually operated to being electronically-controlled or powered by electricity rather than human power. This change could greatly increase the case of operation and response time, which can be vital in an emergency. An electronic control system could introduce features like remote operation or automated navigation systems, and an electric power source might equip the vehicle with sustainable energy use and greater speed capabilities, ensuring robust and immediate response in crises.

In one or more embodiments, this disclosure describes a man-powered vehicle that may provide bullet resistance, aiming to protect individuals during mass shooting events.

In one or more embodiments, the dimensions of the vehicle may allow it to pass through standard 35-inch by 84-inch doors found in K-12 schools, colleges, and various buildings.

In one or more embodiments, its walls, potentially made of ballistic metal and glass, could offer varying thicknesses for protection: approximately 20 to 24 inches at the front, about 16 to 18 inches at the rear, between 16-20 inches at the bottom, and roughly 6 to 8 inches at the top.

In one or more embodiments, this vehicle may be capable of moving forward and backward, as well as turning left and right.

In one or more embodiments, it might accommodate drivers ranging in height from 4 feet 6 inches to 6 feet 6 inches tall, which could include underaged students and adult faculty members.

In one or more embodiments, with a weight possibly exceeding 1,500 pounds, the vehicle might incorporate a system that significantly amplifies human power by 200 to 300 times, enabling it to move at speeds varying from a slow 1 inch per second to greater than 30 inches per second, depending on gear size adjustments.

In one or more embodiments, the vehicle may be self-locking, designed to resist being pushed or pulled out of position by manpower.

In one or more embodiments, there may be designated spots on the vehicle for deploying pepper sprays and taser guns.

In one or more embodiments, the vehicle could be equipped with mechanisms to turn and open unlocked door handles.

In one or more embodiments, it may use at least four non-pneumatic tires and could have all wheels encased by at least 4 inches of ballistic metal on all sides, except the bottom that makes contact with the floor.

In one or more embodiments, typically intended for indoor usage, such as hallways or classrooms within educational facilities, elevators, meeting rooms, public areas of corporate buildings, shopping malls, and industrial campuses, the vehicle is suggested for environments where maneuverability and size may be critical.

In one or more embodiments, being non-electronic, the vehicle might operate without batteries, relying solely on human power for its operation and control.

The above descriptions are for illustration and are not meant to be limiting. Numerous other examples, configurations, processes, algorithms, etc., may exist, some of which are described in greater detail below. Example embodiments will now be described with reference to the accompanying figures.

The envisioned man-powered Bullet-Resistant Vehicle for Mass-shooting Events is a tripartite system designed to navigate, defend, and counteract threats. It primarily includes a Navigation System that allows for riding and precise steering, ensuring that the operator can maneuver the vehicle swiftly to safety or towards an area that requires protection. The Defense System incorporates bullet-resistant covers, a fortified entrance, and robust wheels to safeguard the driver from potential gunfire. Lastly, the Offense System is equipped with mechanisms to strategically deploy pepper sprays and taser guns, providing means to incapacitate an active gunman during critical moments.

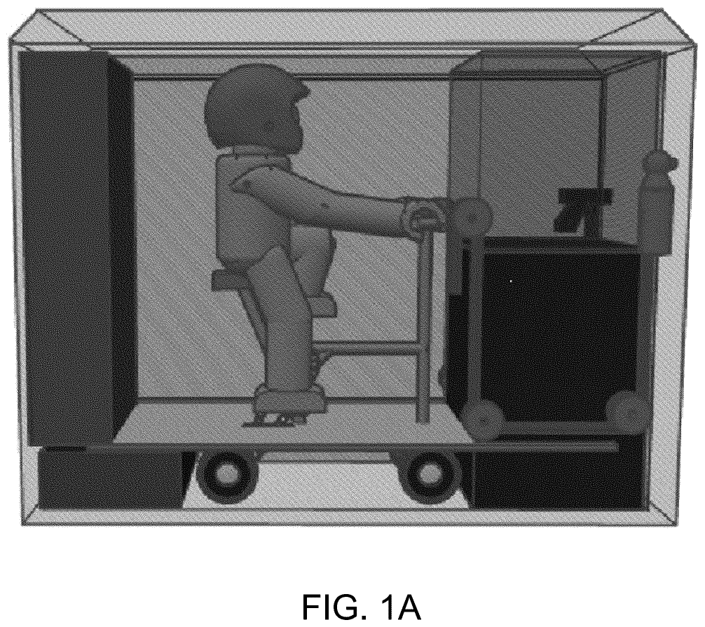

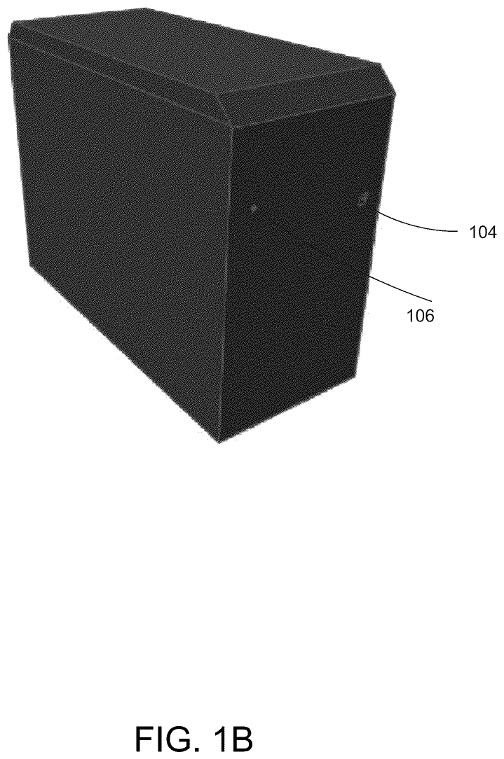

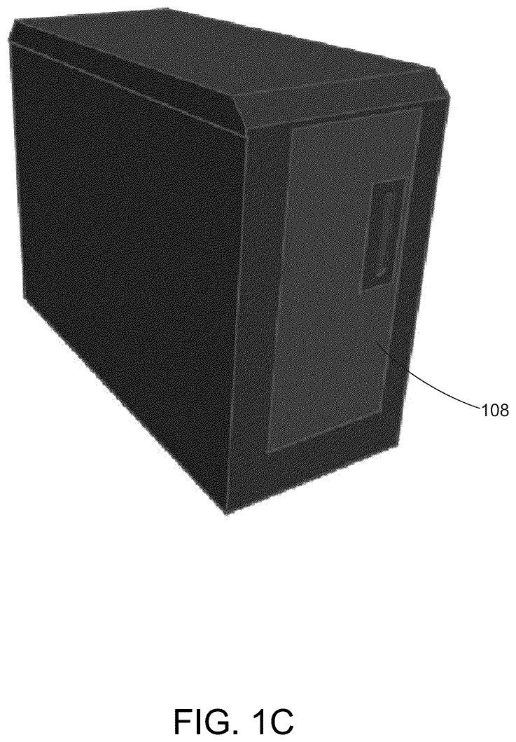

FIGS. 1A-IC depict illustrative schematic diagrams for Modular Safety Vehicle, in accordance with one or more example embodiments of the present disclosure.

FIG. 1A shows a person operating the Modular Safety Vehicle system while enclosed. FIG. 1B shows the exterior of the Modular Safety Vehicle system showing the front of the vehicle, where the two holes (104 and 106) that the Offense System may utilize. FIG. 1C shows the exterior of the Modular Safety Vehicle system showing the back of the vehicle, where there exists a door 108 for entry and exit of the vehicle.

It is understood that the above descriptions are for illustration and are not meant to be limiting.

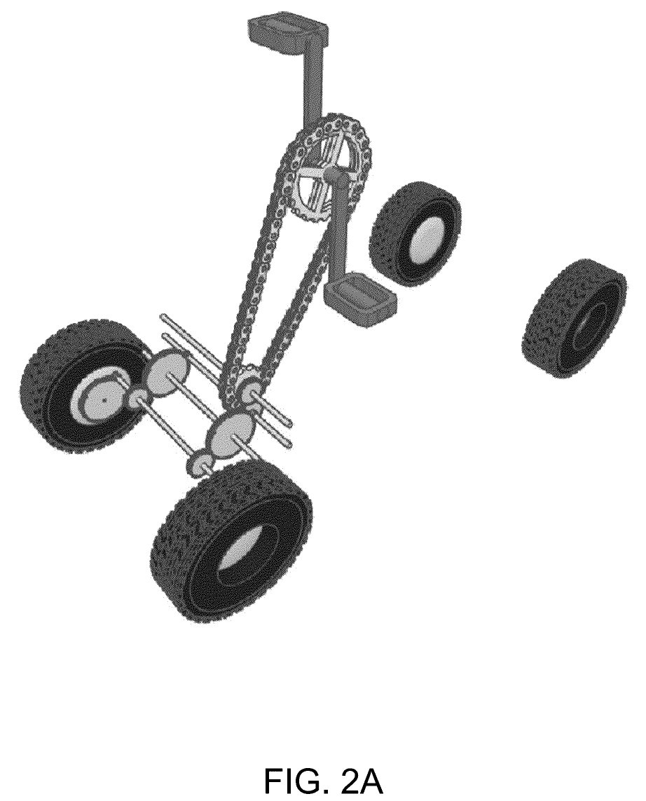

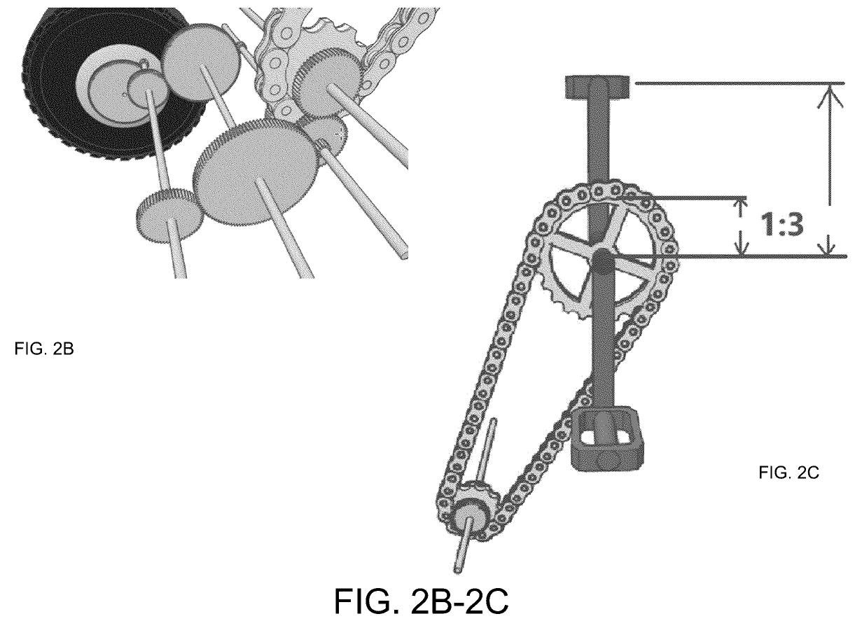

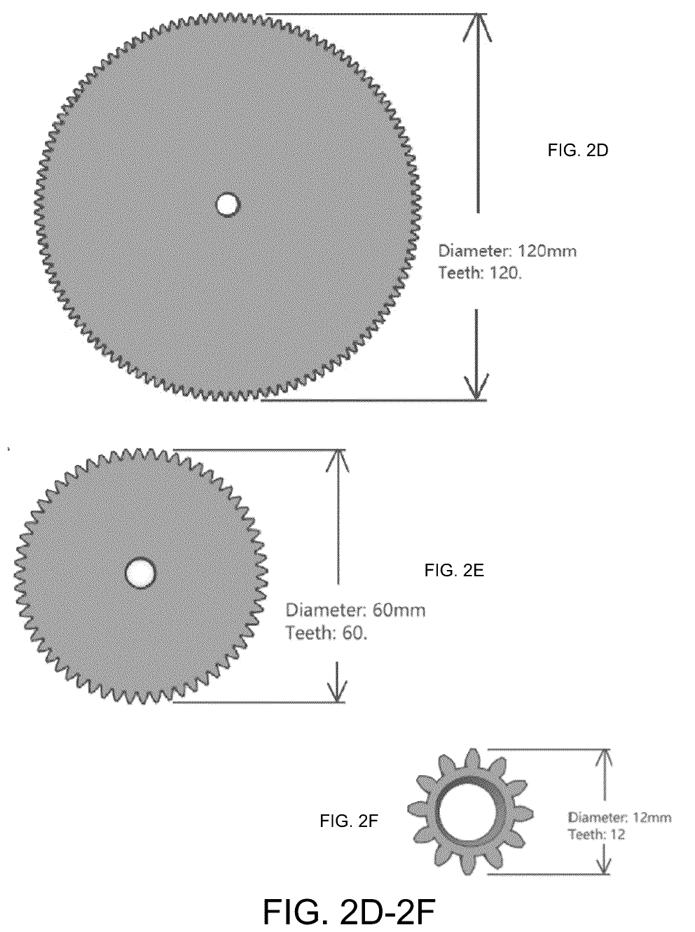

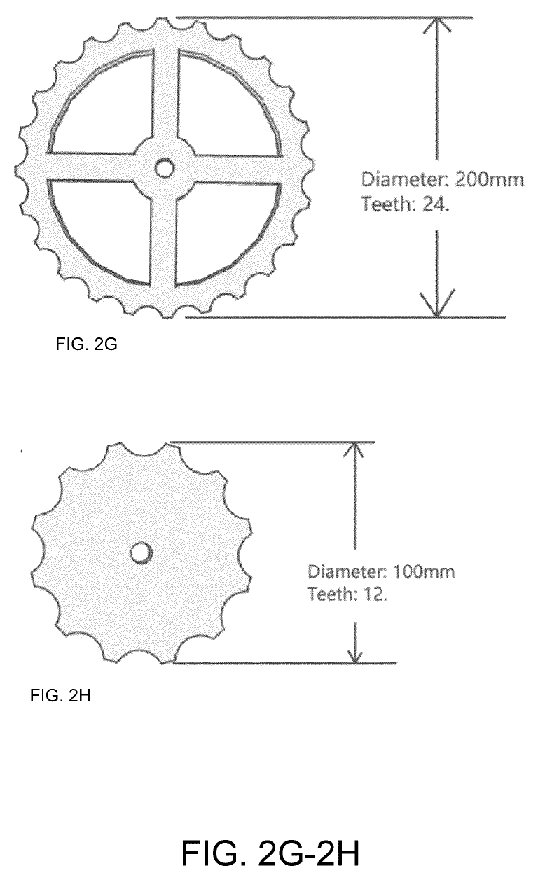

FIGS. 2A-2H depict illustrative schematic diagrams for Modular Safety Vehicles, in accordance with one or more example embodiments of the present disclosure.

FIG. 2 depicts an illustrative schematic diagram for a Modular Safety Vehicle, in accordance with one or more example embodiments of the present disclosure.

Referring to FIG. 2, there is shown the components used in the navigation system.

For the navigation system, the steering and riding part is no different from an ordinary bicycle, so that everybody from a healthy first-grade school student to a healthy 80-year-old grandparent can operate it, even if they do not know how to or cannot ride a bicycle. This universal design approach ensures inclusivity, allowing users of virtually any age and capability to engage with the vehicle's controls with a minimal learning curve. As an enhancement, ergonomic handlebars and adjustable seating could be incorporated to tailor the physical interface to individual user needs for improved accessibility and comfort. What makes the navigation system different is the powertrain part hiding beneath the rider's room floor, located at the back-half bottom. This hidden compartment might house an innovative gearing system or a mechanical multiplier that amplifies the rider's input to achieve greater velocities or navigate challenging terrains efficiently.

This powertrain, as shown in the images, magnifies the pedal force by about 300 times and keeps the moving speed of the vehicle at less than 1 foot per second. This impressive force magnification is crucial for enabling users with varying levels of physical strength to operate the vehicle without undue exertion. As an enhancement, advanced lightweight materials in the powertrain's construction could further improve efficiency and reduce the overall effort required to operate the vehicle.

The details on the power and speed transmission are listed below-Mechanic Gears-Large:Medium:Small Teeth:120, 60, 12. (=10:5:1) Radius: 60 mm, 30 mm, 6 mm. (=10:5:1). These ratios indicate a carefully engineered gear system designed to optimize the transfer of human power into mechanical movement. Enhancements here could include precision-engineered gears made from high-strength composites for durability and reduced friction.

Solid Rubber Wheel Radius: 6 inches=150 mm. The choice of a solid rubber wheel reduces maintenance, as there are no pneumatic components to puncture, which is vital in emergencies. An enhancement could be treads designed for maximum traction on various indoor surfaces to ensure stability and control.

Paddle Arm Length: 300 mm. Paddle Gear Radius: 100 mm. The lengths and radii mentioned here relate directly to leverage and mechanical advantage, ensuring that the user can generate ample force with each pedal stroke. Including adjustable arms or gears could allow for different users to modify the vehicle to suit their physical stature and strength.

Wheel-side Paddle Gear Radius: 50 mm. Paddle arm length: paddle gear radius=3:1; =>speed=1:1, force=3:1; Paddle gear radius: wheel-side gear radius=2:1=>speed=2:1, force=1:1; Radius: 100:50 mm (2:1), Teeth: 24:12. (2:1). The described lever and gear ratios signify a user-friendly interface for maximizing force output without compromising control. A possible enhancement might be an intuitive control panel that provides real-time feedback on force output and speed.

Force magnification rate: (3:1)*(2:1)*(1:1)*(5:1)*(10:1)*(5:10)*(5:1)*(10:1)*(1:5)=1500 times, theoretically. It should be around 300 times for the Real Prototype in a picture or expectedly can be 500 times for a working product. Other numbers may also be possible. The calculated force amplification outlines the vehicle's potential in various working scenarios, showcasing its robust design. Implementing sensor technology could track and adjust the force applied, optimizing performance and user safety.

Thus a child using it can move the three to five thousand pounds vehicle, and can still move some thousands of pounds weight of some obstacles on its path, such as desks and chairs in classrooms and hallways, and can also overwhelm the strength of any gunman's physical force and can push the gunman away or corner the gunman, or drag or carry some tools for police and rescuers into the scenario, typically into the school hallways and classrooms, or can be attached some extra tools and weapons on its sides and top. The ability of a single child to achieve all this illustrates the potential for empowering individuals in crisis situations. As an enhancement, strategic attachment points for tools and rescue equipment could be added to increase the vehicle's utility in emergency scenarios.

Speed transmission rate: 2:1*1:1*1:1*1:1*1:10*10:5*1:1*1:10*1:1= 1/25 times, theoretically. In reality, it should also be nearly 25 times slower than the paddling speed in Rounds-per-Second unit. However, other speeds may also be used. This reduction in speed is a strategic decision to prioritize control and safety over speed. An organic enhancement might be the introduction of a variable transmission system allowing the user to adjust the speed to their capability and the situation's requirements.

Thus, a child or an adult in it can move the vehicle at about ⅓ foot per second to 4/3 foot per second, 1 r/s* 1/25*30 cm*3.14=3.8 cm/s, paddling at 3 r/s is at about ⅓ foot per second, 9 r/s is at about 1 foot per second. This considered design choice facilitates movement that is both deliberate and precise. Introducing motion dampeners could ensure smooth movement, reducing jolts that may occur with rapid starts and stops. At this speed range, children with curiosity will not occupy the vehicle for fun or use it to bully others. This inherent speed limit acts as a natural deterrent to misuse, ensuring that the vehicle remains a dedicated safety apparatus. To further enhance this aspect, smart-lock mechanisms activated by authorized users could prevent unauthorized access and misuse. Within this speed limit, the vehicle can be used as a cover for policemen and rescuers on the opposite side of the gunman and can move together to approach the gunman. By functioning as a mobile shield, the vehicle not only protects but also assists in tactical response efforts. Enhancements such as integrated communication devices could facilitate better coordination between the user and law enforcement, enabling strategic approaches in hostile situations.

It is understood that the above descriptions are for the purposes of illustration and are not meant to be limiting

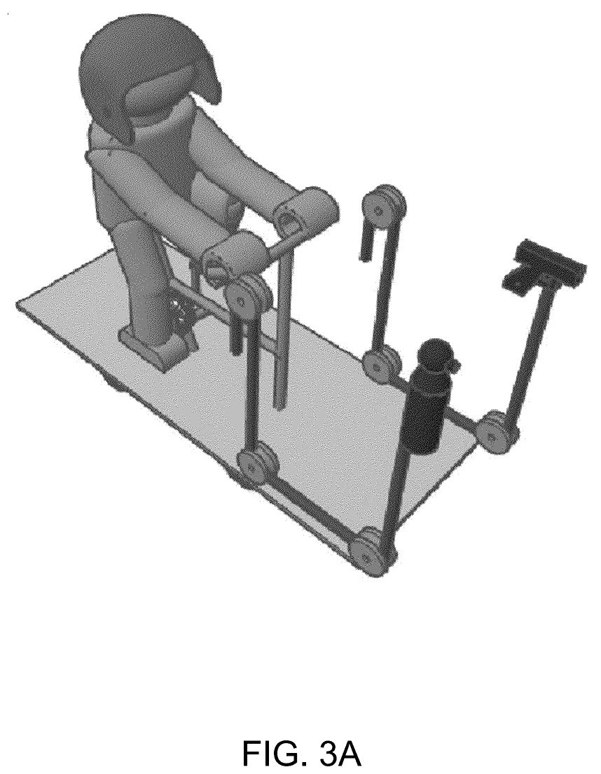

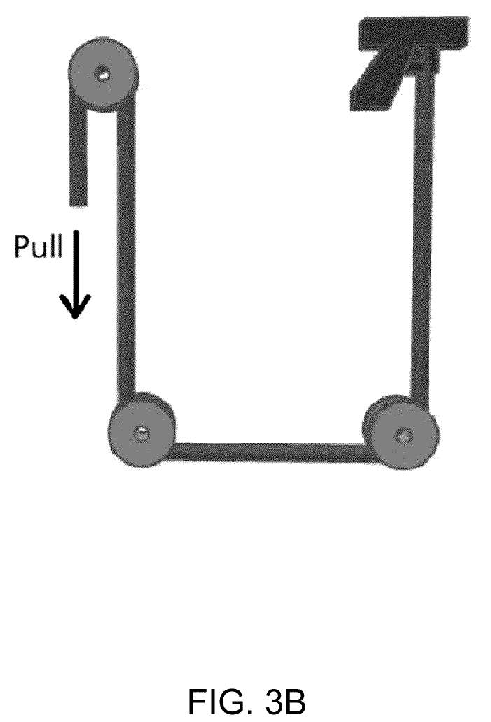

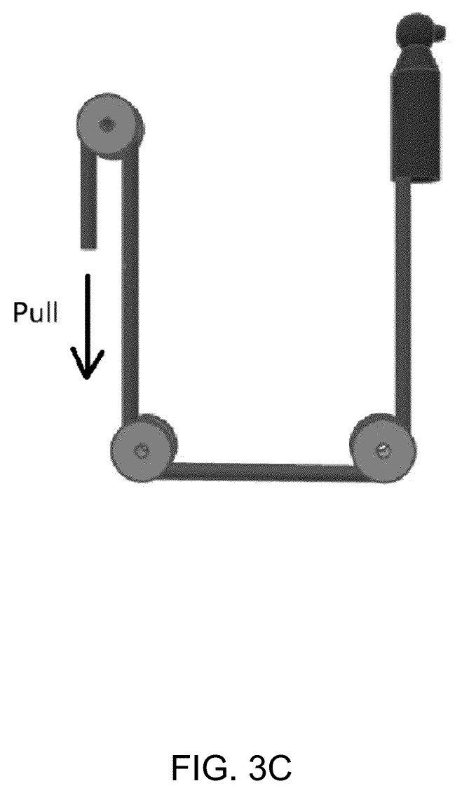

FIGS. 3A-3C depict illustrative schematic diagrams for a Modular Safety Vehicle, in accordance with one or more example embodiments of the present disclosure.

In one or more embodiments, at the front of the vehicle, there is a set-up that includes one portion dedicated to deploying pepper sprays and another for operating taser guns. This configuration ensures a measured response capability, providing non-lethal force as a means to subdue a potential threat swiftly and efficiently. Enhancements can entail the integration of advanced targeting algorithms within the system to ensure precise application of the defensive mechanisms.

In one or more embodiments, the rider can simply pull a metal rope to activate and discharge the weapons. This design emphasizes user-friendly interfaces, making it possible to react quickly and decisively in high-pressure scenarios without complicated maneuvers. An ergonomic enhancement might be the addition of reinforced grip points on the metal rope, molded to fit the fingers securely, ensuring the weapons can be deployed with minimal effort even when wearing gloves or in slippery conditions.

In one or more embodiments, the vehicle is equipped with multiple pepper spray canisters and taser guns, and perhaps a variety of other widely accepted self-defense tools. Such an assortment allows for a tailored response to different levels of threat while ensuring that the rider has a series of defensive options at hand. A user-centric enhancement could be the development of a selection interface located within easy reach of the rider, which would permit the swift change from one defense tool to another without needing to look away from potential dangers.

In one or more embodiments, these weapons are strategically placed at various elevations, and at least one taser gun is positioned along the lower half's central vertical axis on the front, making it more straightforward to hit a target than if it were positioned on the flanks. Positioning weapons at different heights and in centrally focused areas provides tactical advantage and increases the accuracy rate against potential threats. An enhancement in this regard could be a motorized pivot mechanism, enabling the lower taser gun to adjust its angle automatically, compensating for distance or the movement of the target.

In one or more embodiments, the weapons' muzzles are discreetly embedded within the camouflage design that covers the front of the vehicle, making them less likely to be detected unless closely inspected, and consequently harder to be deliberately targeted. This stealth feature diminishes the likelihood that an assailant could anticipate and counteract a defensive response, thereby increasing the protection offered to the vehicle's occupants. An innovative enhancement could involve the use of materials with adaptive pigmentation, which change color or pattern to match the surrounding environment, rendering the weapons near-invisible until they are deployed.

It is understood that the above descriptions are for the purposes of illustration and are not meant to be limiting.

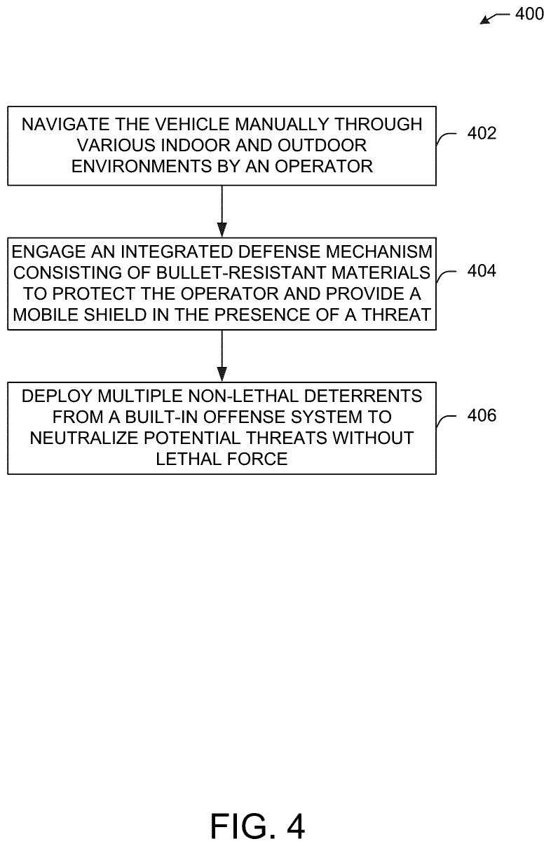

FIG. 4 illustrates a flow diagram of illustrative process 400 for a Modular Safety Vehicle system, in accordance with one or more example embodiments of the present disclosure.

At block 402, a vehicle may navigate the vehicle manually through various indoor and outdoor environments by an operator.

At block 404, the vehicle may engage an integrated defense mechanism consisting of bullet-resistant materials to protect the operator and provide a mobile shield in the presence of a threat.

At block 406, the vehicle may deploy multiple non-lethal deterrents from a built-in offense system to neutralize potential threats without lethal force.

It is understood that the above descriptions are for the purposes of illustration and are not meant to be limiting.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A protective vehicle comprising:
a navigation system including a gearing arrangement, wherein the gearing arrangement designed to amplify pedal force exerted by an operator of the vehicle;
a defense system comprising a bullet-resistant cover for driver protection; and
an offense system equipped to deploy non-lethal weapons.

2. The vehicle of claim 1, wherein the gearing arrangement amplify pedal force by a minimum of 300 times, sustaining a vehicle movement speed of less than 1 foot per second.

3. The vehicle of claim 1, wherein the offense system is capable of being discreetly embedded within a front side of the vehicle to camouflage a position of the weapons.

4. The vehicle of claim 1, wherein the offense system comprises one or more pepper sprays and one or more taser guns positioned at various heights.

5. The vehicle of claim 1, wherein the defense system is further defined by its ability to withstand impacts from weapons commonly used in mass shootings.

6. The vehicle of claim 1, wherein a camouflage design employs advanced materials capable of adaptive coloration to match an operational environment.

7. The vehicle of claim 1, further comprising a storage system for non-lethal weapons with strategic placements and concealment features.

8. An emergency response vehicle with human-powered operation and indoor and outdoor adaptability, capable of being utilized in high-risk areas for protection during an emergency, comprising:
a manually operable control system for navigation;
an integrated defense mechanism consisting of bullet-resistant materials; and
a built-in offense system with multiple non-lethal deterrents.

9. The vehicle of claim 8, wherein the offense system includes a set of pepper spray and taser gun shooting systems.

10. The vehicle of claim 8, wherein at least one taser gun is strategically positioned along a central vertical axis of a front side's lower half.

11. The vehicle of claim 8, wherein the multiple non-lethal deterrents of the offense systems are actuated by a pull of a metal rope by a rider.

12. The vehicle of claim 8, wherein the multiple non-lethal deterrents are positioned to allow for the use of the vehicle as a mobile shield.

13. The vehicle of claim 8, wherein the control system for navigation includes an adjustable interface to accommodate users of various physical attributes.

14. The vehicle of claim 8, wherein the built-in offense system includes sensory technology to automatically target and engage with potential threats.

15. A security apparatus for an emergency response vehicle designed for use during high-risk situations, comprising:
a self-locking feature that prevents movement by external manpower when in a stationary position, providing added security; and
mechanisms to enable force amplification of human power for propelling the vehicle.

16. The apparatus of claim 15, wherein the mechanisms include a force magnification rate that allows the movements of the vehicle by an operator unassisted.

17. The apparatus of claim 15, wherein the security apparatus further comprises a propulsion system with a variable transmission to adjust the movement speed according to operator capabilities and situational demands.

18. The apparatus of claim 15, further comprising an intuitive system for selecting between multiple non-lethal weapons based on situational analysis.

19. The apparatus of claim 15, wherein the apparatus includes an adjustable seating arrangement to accommodate operators of varying heights and build.

20. The apparatus of claim 15, wherein the apparatus is equipped with communication devices to facilitate coordination with emergency response teams.
